(19) United States
(12) Patent Application Publication
(10) Pub. No.: US 2014/0352155 A1
(43) Pub. Date: Dec. 4, 2014

(54) HAND-HELD ELECTRIC POWER TOOL WITH A SUCTION ADAPTER

(71) Applicant: Hilti Aktiengesellschaft, Schaan (LI)

(72) Inventors: Markus Looser, Landsberg (DE); Konstantin Baxivanelis, Kaufering (DE); Guenter Haas, Kaufering (DE); Bernhard Link, Schwabbruck (DE)

(21) Appl. No.: 14/461,075

(22) Filed: Aug. 15, 2014

Related U.S. Application Data
(62) Division of application No. 13/199,903, filed on Sep. 13, 2011, now abandoned.

(30) Foreign Application Priority Data
Sep. 24, 2010 (DE) DE102010041352.6

(51) Int. Cl. B23Q 11/00; B23D 59/00; B24B 55/10; B25F 5/00

(52) U.S. Cl. CPC B23Q 11/0046; B25F 5/00; B23D 59/006; B24B 55/102
USPC 30/124; 173/198; 451/359; 83/100

(57) ABSTRACT

A hand-held electric power tool having a tool that can be rotated around a rotational axis by the drive unit, having a protective cover that at least partially surrounds the tool, having an outlet opening that conveys out of the protective cover the material removed from the workpiece that is to be machined, and having a suction adapter that is connected to the protective cover and that has a connection section with a suction opening for connecting a suction device, the suction adapter having a guide device for guiding the material being removed, the guide device having an outlet opening that differs from the suction opening.

This is a Divisional Application of U.S. Ser. No. 13/199,903, filed Sep. 13, 2011 and claims the benefit of German Patent Application DE 10 2010 041 352.6 dated Sep. 24, 2010. Both applications are hereby incorporated by reference herein.

The present invention relates to a hand-held electric power tool.

### BACKGROUND

Hand-held electric power tools such as a manual circular saw, an angle grinder, a disk grinder or a slitting device are operated either with a suction device or without a suction device.

A manual circular saw comprises a circular saw blade that is driven around an axis of rotation by a drive unit, and a contact plate that is placed onto a workpiece that is to be machined. With manual circular saws, it is important to guide the chips so that the chips that are flying around cannot strike the operator. For this reason, curved protective covers surround the upper half of the saw blade. These protective covers are flush with the contact plate. The bottom of the flat contact plate forms a workpiece contact surface with which the circular saw slides along the surface of the workpiece.

Prior-art protective covers have an outlet opening for the chips through which the chips are thrown from the saw blade to the outside. In order for a suction device to be able to suction off the chips, a suction adapter is provided that can be inserted into the outlet opening of the protective cover and that is clamped onto the protective cover. The circular saw can be used either with or without a suction adapter, but when the suction adapter has been put in place, the circular saw can only be operated with a suction device.

A drawback is that, in order to operate the electric power tool without a suction device, the suction adapter has to be removed from the protective cover. Moreover, there is a risk that the tubular connecting piece could become clogged with chips.

### SUMMARY OF THE INVENTION

An object of the present invention is to improve the removal of chips that the electric power tool removes from the workpiece. Furthermore, switching between operation of the electric power tool with a suction device and operation without a suction device should be simplified for the user.

According to the invention, it is provided that the suction adapter has a guide device for guiding the material being removed, said guide device having an outlet opening that differs from the suction opening. The outlet opening that differs from the suction opening serves as an outlet opening for the material being removed when the electric power tool is being used without a suction device, and it regulates the air feed into the suction duct when the suction device is connected to the suction adapter. This has the advantage that the suction adapter does not have to be removed from the protective cover when the electric power tool is going to be operated without a suction device.

In a preferred embodiment, the suction adapter is integrated into the protective device or permanently connected to the protective device. This has the advantage that the suction adapter is inseparably connected to the protective cover and that the electric power tool is always ready for use.

In an alternative embodiment, the suction adapter can be detachably connected to the protective device. The detachability of the suction adapter offers the operator the possibility of removing the suction adapter from the protective cover if, for example, the suction adapter is hindering the machining process.

Especially preferably, the guide device has a first guide section that is arranged on the protective cover, and a second guide section that is arranged on the suction adapter and that surrounds the outlet opening. The direction of the emerging material being removed is determined by the shape of the first and second guide sections. Especially preferably, the second guide section comprises a cover element that delimits a volume element and a directing device that determines the direction of the material being removed.

In a preferred embodiment, the outlet opening is configured so as to be adjustable by means of a slide element. The adjustability of the outlet opening offers the operator the possibility to regulate the air feed into the suction duct when a suction device is connected to the suction adapter so as to prevent clogging of the suction duct. Furthermore, since the air stream can be adapted via the adjustable outlet opening, it is possible to use suction devices of different power levels, which require a different air stream to achieve an ideal operating state.

Embodiments of the invention will be described below on the basis of the drawing. The drawing does not necessarily depict the embodiments true-to-scale, but rather, it is presented in schematic and/or slightly distorted form whenever this serves for purposes of illustration. Regarding additions to the teaching that can be derived directly from the drawing, reference is hereby made to the pertinent state of the art. In this context, it should be taken into consideration that many modifications and changes can be made in terms of the form and the details of a given embodiment, without departing from the general idea of the invention. The features of the invention disclosed in the description, in the drawing as well as in the claims, be it individually or in any desired combination, can all be essential for refining the invention. Moreover, all combinations of at least two of the features disclosed in the description, in the drawing and/or in the claims fall within the scope of the invention. The general idea of the invention is not limited to the exact form or details of the preferred embodiment shown and described below, nor is it limited to a subject matter that would be restricted in comparison to the subject matter claimed in the claims. Regarding the dimensional ranges given, values that fall within the cited limits can also be disclosed as limit values and can be employed and claimed as desired. For the sake of simplicity, the same reference numerals will be used below for identical or similar parts or for parts having an identical or a similar function.

### BRIEF DESCRIPTION OF THE DRAWINGS

The following is shown:

FIG. 1 a side view of a manual circular saw according to the invention;

FIG. 2 the protective cover of the manual circular saw with a suction adapter according to the invention that has been placed into an outlet opening and that is connected to the protective cover;

FIGS. 3A, B the suction adapter in a side view (FIG. 3A) and in a sectional view along the line A-A (FIG. 3B); and

FIGS. 4A, B an alternative embodiment of the suction adapter with a closable outlet opening in a first position with a maximum outlet opening (FIG. 4A) and in an intermediate position with a reduced outlet opening (FIG. 4B).

### DETAILED DESCRIPTION

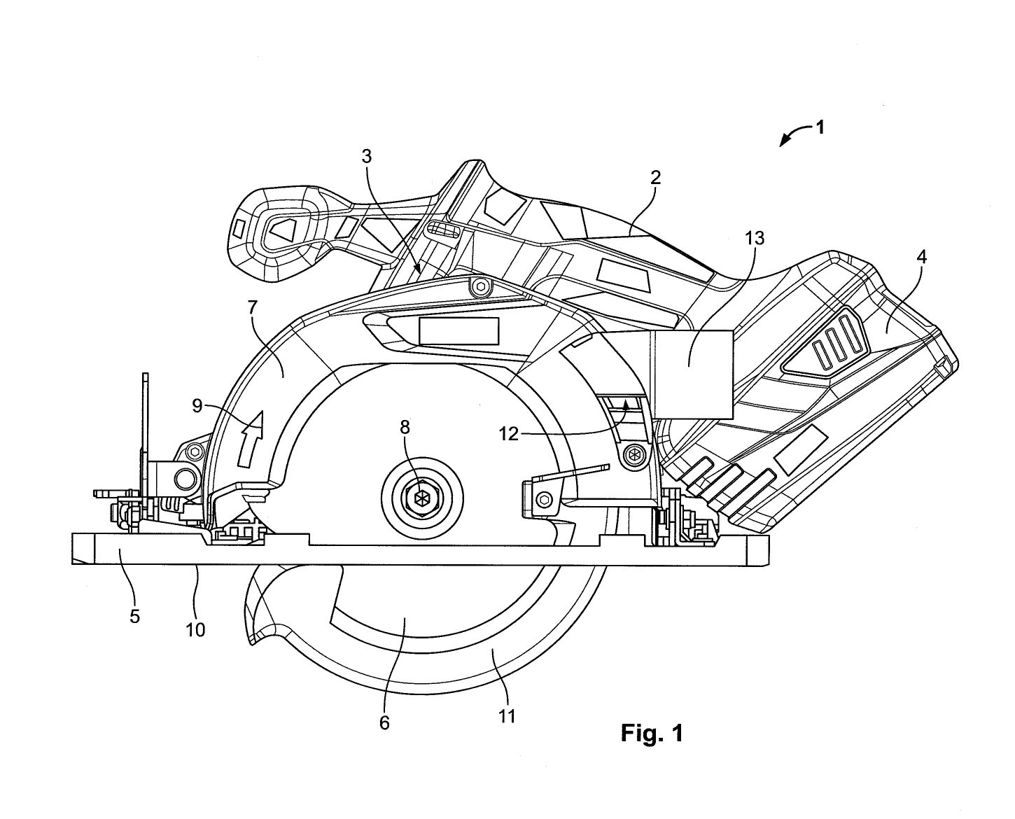

FIG. 1 shows a hand-held electric power tool that is configured as an electric manual circular saw 1. The structure of the manual circular saw 1 corresponds essentially to that of a conventional manual circular saw with a handle 2, a drive unit 3 that is supplied by a rechargeable battery 4, a contact plate 5 and a tool configured as a saw blade 6 that extends through a cutout in the contact plate 5 and that is partially surrounded by an upper protective cover 7 that has a curved shape. The saw blade 6 is driven around a rotational axis 8 in a direction of rotation 9 by the drive unit 3. The bottom of the contact plate 5 forms a workpiece contact surface 10 with which the manual circular saw 1 is placed onto a workpiece that is to machined and then guided along the surface of the workpiece. At the bottom of the contact plate 5, the saw blade 6 is surrounded by a pivoting lower protective cover 11 that is configured as a swinging protective hood.

The upper protective cover 7 covers the saw blade 6 in the area above the contact plate 5. For one thing, this serves to protect the operator from being injured by the saw blade 6. Secondly, the operator is protected against flying chips or other material that the saw blade 6 removes from the workpiece. Immediately after the saw blade 6 is lifted off the workpiece, material that has been removed from the workpiece by the saw blade 6 is thrown against the protective cover 7 along a straight line that runs tangentially to the saw blade 6 and then conveyed by the protective cover 7 to the outlet opening 12. The outlet opening 12 is situated on the side of the protective cover 7 facing away from the handle 2. A suction adapter 13 is inserted into the outlet opening 12 of the protective cover 7 and connected thereto.

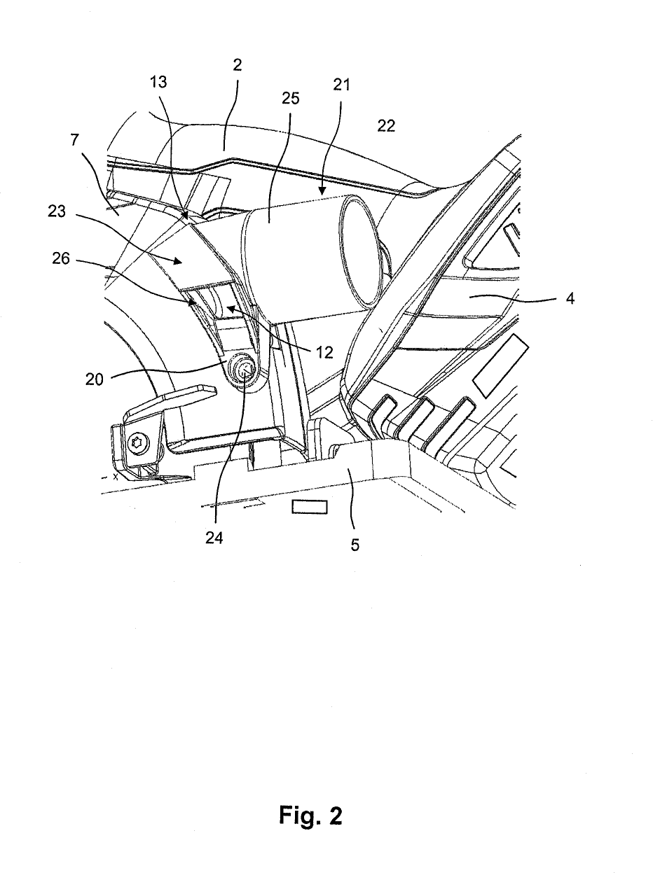

FIG. 2 shows the protective cover 7 of the manual circular saw 1 with the suction adapter 13 that is inserted into the ejection opening 12 and that is connected to the protective cover 7.

The suction adapter 13 consists of a fastening section 20 for fastening the suction adapter 13 to the protective cover 7, of a suction connecting section 21 with a suction opening 22 for connecting a suction device, and of a guide device 23 for guiding the material being removed.

The manual circular saw 1 can be operated in a suction mode with a suction device, for example, in the form of a vacuum cleaner. The suction device generates a suction flow that draws in the removed material through the suction connecting section 21. Aside from the suction mode, the manual circular saw 1 can also be operated in a second mode without the suction device.

The fastening section 20 is clamped or fastened in some other manner to the protective cover 7 by means of a screwed connection 24 or by a comparable connecting means.

The suction connecting section 21 consists of a tube element 25 that is connected at one end to the guide device 23 and that has the suction opening 22 at the other end. A suction tube of a suction device can be connected to the tube element 25. The tube element 25 has, for example, a ribbed outer surface or it is provided with thread-like or screw-like indentations that serve to connect the suction tube.

The guide device 23 has an outlet opening 26 that faces the outlet opening 12 in the protective cover 7 and that serves as an outlet opening for the material being removed when the manual circular saw 1 is being operated without a suction device. If a suction device is connected to the suction adapter 13, then the air feed into the suction duct is regulated via the outlet opening 26.

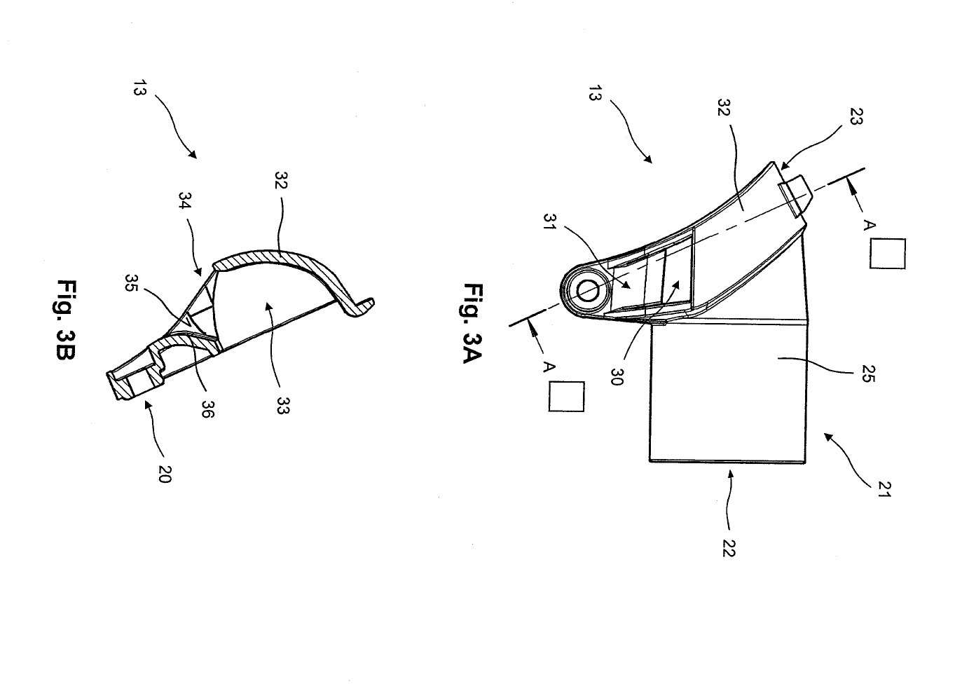

FIG. 3A shows a side view of the suction adapter 13 that can be inserted into the outlet opening 12 of the protective cover 7, and FIG. 3B shows a sectional view through the guide device 23 along the line A-A.

The guide device 23 is configured in such a way that the removed material is reliably transported out of the protective cover 7 without a suction device. For this purpose, a first guide section 30 is provided in the protective cover 7, and a second guide section 31 is provided in the suction adapter 13. The second guide section 31 comprises a cover element 32 that delimits a volume element 33 and a directing device 34 that determines the direction of the emerging material being removed. The directing device 34 comprises a lateral guide element 35 and a ramp 36.

The size of the volume element 33 is set in such a way that, to the greatest extent possible, the material being removed can move to the outside without accumulating. For this purpose, an adequate flow cross section has to be provided.

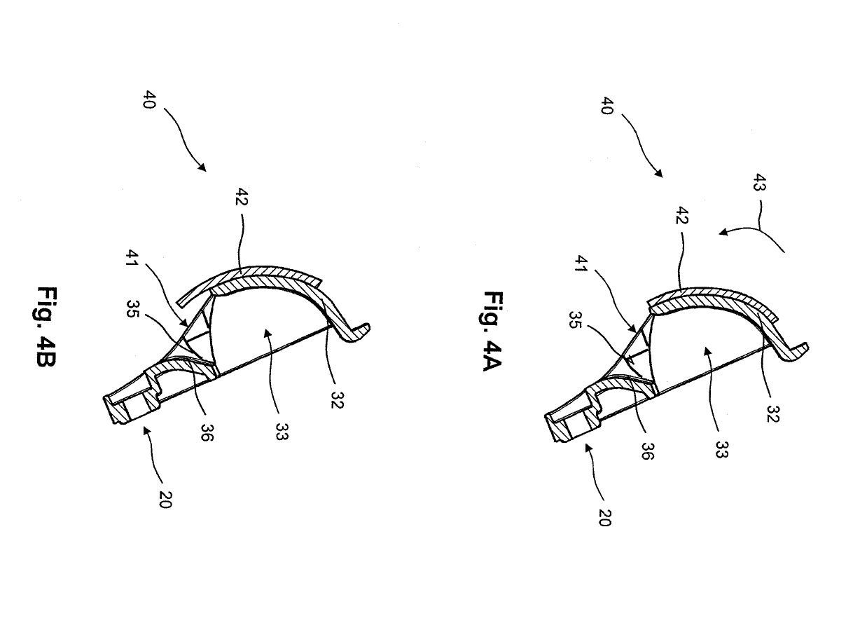

FIGS. 4A, B show an alternative embodiment of a suction adapter 40 with an adjustable outlet opening 41.

The outlet opening 41 can be closed by means of a slide element 42. The slide element 42 is arranged above the cover element 32 and is configured so as to slide in a sliding direction 43. FIG. 4A shows the slide element 42 in a first end position in which the outlet opening 41 is at its maximum. FIG. 4B shows the slide element 42 in an intermediate position in which the size of the outlet opening 41 is reduced.

The adjustability of the outlet opening 41 via the slide element 42 offers the operator the possibility to regulate the air feed into the suction duct so as to prevent clogging of the suction duct when a suction device is connected to the suction adapter 40. On the other hand, during operation without the suction device, the outlet opening 41 can be set in such a way that the removed material is reliably conveyed to the outside and clogging of the volume element 33 is prevented.

What is claimed is:

1. A hand-held electric power tool comprising:
a drive unit;
a tool rotatable around a rotational axis by the drive unit;
a protective cover at least partially surrounding the tool;
an outlet opening conveying out of the protective cover the material removed from a workpiece to be machined;
a suction adapter connected to the protective cover and having a connection section with a suction opening for connecting a suction device,
the suction adapter having a guide for guiding the material being removed, the guide having a guide outlet opening differing from the suction opening,
the guide outlet opening configured so as to be adjustable by a slide element.

2. The electric power tool as recited in claim 1 wherein the suction adapter is integrated into the protective cover or permanently connected to the protective cover.

3. The electric power tool as recited in claim 1 wherein the suction adapter is detachably connected to the protective cover.

4. The electric power tool as recited in claim 3 wherein the guide has a first guide section arranged on the protective cover, and a second guide section arranged on the suction adapter and surrounding the guide outlet opening.

5. The electric power tool as recited in claim 4 wherein the second guide section includes a cover element delimiting a volume element, and a directing device determining a direction of the material being removed.

6. The electric power tool as recited in claim 1 wherein the electric power tool is configured as a circular saw, an angle grinder, a disk grinder or a slitter.
